(19) United States
(12) Patent Application Publication
(10) Pub. No.: US 2017/0142976 A1
(43) Pub. Date: May 25, 2017

(54) PLANT VASCULAR DISEASE TREATMENT COMPOSITION

(71) Applicant: FAIRHAVEN VINEYARDS, Hawkins, TX (US)

(72) Inventor: Ronald Linwood Winters, Hawkins, TX (US)

(73) Assignee: FAIRHAVEN VINEYARDS, Hawkins, TX (US)

(21) Appl. No.: 15/058,557

(22) Filed: Mar. 2, 2016

Related U.S. Application Data
(60) Provisional application No. 62/260,082, filed on Nov. 25, 2015.

(51) Int. Cl. A01N 63/00; A01G 7/06; A01N 37/40; A01N 25/10; A01N 25/34

(52) U.S. Cl. CPC A01N 63/00; A01N 25/10; A01N 25/34; A01N 37/40; A01G 7/06

(57) ABSTRACT

A composition including a lyophilized bacteriophage or an expression thereof present in an amount effective for the elimination of Xylella fastiodisa or Xanthomonas in a plant. The lyophilized bacteriophage or an expression thereof is further combined with a bacteriophage nutrient and a water soluble polymer.

### CROSS-REFERENCE TO RELATED APPLICATION

This application claims the benefit of priority of U.S. provisional application No. 62/260,082, filed Nov. 25, 2015, the contents of which are herein incorporated by reference.

### BACKGROUND OF THE INVENTION

The present invention relates to a pharmaceutical composition for the treatment of plant vascular disease and, more particularly, to a composition of water soluble polymers mixed with a bacteriophage and a bacteriophage nutrient for the treatment of Xylella fastidiosa and Xanthomonas.

Xylella fastidiosa, a bacterium in the class Gammaproteobacteria, is an important plant pathogen that causes Pierce's disease in grapevines. Pierce's disease (PD) was discovered in 1892 by Newton B. Pierce (1856-1916; California's first professional plant pathologist) on grapes in California near Anaheim. The disease is endemic in northern California, being spread by the blue-green sharpshooter, which attacks grapevines that are adjacent to riparian habitats, and other environs.

When a vine becomes infected, the bacterium causes tyloses to form in the xylem tissue of the vine, preventing water from being drawn through the vine. Leaves on vines with Pierce's disease will turn yellow and brown, and eventually drop off the vine. Shoots will also die. After one to five years, the vine itself will die. The proximity of vineyards to citrus orchards compounds the threat, because citrus is not only a host for the sharpshooter eggs, but it is also a popular overwintering site for the insect. Likewise, oleander, a common landscaping plant in California, serves as a reservoir for Xylella.

Xanthomonas is a genus of Proteobacteria, many of which cause plant disease. Xanthomonas species can cause bacterial spots and blights of leaves, stems, and fruits on a wide variety of plant species.

Historically to prevent Xylella fastidiosa and Xanthonomas from infecting plants, a variety of insect control compounds are used. The insecticidal compounds directly kill the host insect by contact, or indirectly kill the host by application of a lethal dose of the chemical to the target plant through spraying or chemigation. This method promotes oral ingestion by vector insects during feeding on the vines. However, the use of these toxic chemical compounds has a negative environmental impact. Further, food produce may be tainted and consumed by humans.

As can be seen, there is a need for an improved method of treatment of plants for Xylella fastidiosa and Xanthonomas infections.

### SUMMARY OF THE INVENTION

In one aspect of the present invention, a pharmaceutical composition comprises a lyophilized bacteriophage or an expression thereof present in an amount effective for the treatment of Xylella fastiodisa or Xanthonomas in a plant, a bacteriophage nutrient, and a water soluble polymer.

These and other features, aspects and advantages of the present invention will become better understood with reference to the following drawings, description and claims.

### BRIEF DESCRIPTION OF THE DRAWINGS

FIG. 1 is a side view of an embodiment of the outer case of the present invention;

FIG. 2 is a cutaway view of an embodiment of the outer case and the capsule within plant tissue;

FIG. 3 is a top view of an embodiment of the outer case within plant tissue;

FIG. 4A is a side view of an exemplary driver bit;

FIG. 4B is a top view of an exemplary driver bit; and

FIG. 5 is a cutaway view of an exemplary capsule of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a composition of water soluble polymers containing a bacteriophage (phage), a phage nutrient, an enhanced release agent, and an outer film having a disintegrate polymer combined with a tylose suppressor and tylose formation inhibitor. The present invention includes a sequential dispersal beginning with the rapid introduction to the vascular system of the tylose suppressor and formation inhibitor, followed by the long-term release of the phage bio-control agents. The present invention provides for critical seasonal control of the Xylella fastidiosa and/or the Xanthonomas infection and supplies an ongoing prophylactic effect.

The present invention overcomes the issue of the short lifespan of the phages in titer solution (48 hrs) by utilizing lyophilized (freeze-dried) phages at a concentration of about 10̂20 PFU/Mg and then encasing them in a protective polymer. Phages are highly sensitive to UV radiation and, therefore, are placed directly into the plant vascular system in order to be effective in mitigating the Xylella fastidiosa and/or the Xanthonomas infection. The polymer core containing the phages is of a slow dissolving type that releases the phage antigens over the entire critical period of 90 to 730 days. To assure that the phages are provided with sufficient nutrients for survival in dispersion, the phage nutrient is co-mixed with the polymer. Dispersal may be regulated over the delivery period by inclusion of a release enhancement compound.

The present invention includes a composition in the form of a capsule. The capsule includes a lyophilized bacteriophage or an expression thereof present in an amount effective for the treatment and elimination of Xylella fastiodisa or Xanthonomas in a plant. The lyophilized bacteriophage or an expression thereof is further combined with a bacteriophage nutrient and a water soluble polymer.

The water soluble polymer allows for the dissolution of the lyophilized bacteriophage or an expression thereof in the plant for an extended period of time. The water soluble polymer may be made of VRT polymers, which cure at room temperature to form the hardened capsule. For example, the VRT polymer may include a type alpha polymer, such as polydimethysiloxane with a terminal hydroxyl group. The type alpha polymer may be about 65-85% w/w of the capsule. For example, the type alpha polymer may be in the range of about 260 mg up to about 340 mg, about 280 mg up to about 320 mg or about 300 mg. The VRT polymer may further include a type beta polymer, such as tetra-n-propyl-silicate Si(OC3H7)4. The type beta polymer may be about 1-5% w/w of the capsule. For example, the type beta polymer may be in the range of about 4 mg up to about 12 mg, about 6 mg up to about 10 mg or about 8 mg. In alternative embodiments, the water soluble polymer may include a polysimethylsiloxane-vinyl block polymer plus amorphous silica or dimethyl methyl hydrogen siloxane and copolymer plus polydimethylsiloxane in the same amounts listed above.

The water soluble polymer may be mixed with a catalyst, which is intrinsic to the room temperature hardening process. The catalyst may be about 0.2-1.0% w/w of the capsule. For example, the catalyst may be in the range of about 0.8 mg up to about 4 mg, about 1.5 up to about 3 mg or about 2 mg. The catalyst may include stannous octoate Sn(C8H15O2)2. Alternative catalysts may include, but are not limited to, platinum catalyst, tertiary-amine catalyst, polyamine primary/secondary, polyamide, anhydride, boron trifluoride or a combination thereof.

The capsule of the present invention may further include a dispersal enhancement polymer. The dispersal enhancement polymer reduces the clogging of the vascular bundles at the immediate site of implantation and enhances the dispersal of the phage antigens. The dispersal enhancement polymer may be about 10-15% w/w of the capsule. For example, the dispersal enhancement polymer may be in the range of about 40 mg up to about 60 mg, about 45 mg up to about 55 mg or about 50 mg. The dispersal enhancement polymer may include polyvinylpyrrolidone PVP K-30. Alternative dispersal enhancement polymers may include, but are not limited to, microcrystalline cellulose, microcrystalline lactose or a combination thereof.

The lyophilized bacteriophage or an expression thereof may be supplied at range of about 10̂10 PFU/Mg to about 10̂20 PFU/Mg or about 10̂15 PFU/mg. The present invention may utilize any bacteriophage or expression there of that treats Xylella fastiodisa or Xanthonomas in a plant. For example, the bacteriophages may include Siphophages, such as Sano type 103 and Salvo type 16, podophages, such as Prado type 303 and Paz type 306, M13 phage or a combination thereof. The present invention may further utilize an expression of M13 in the form of a single-chain variable fragment (scFv).

The bacteriophage may treat the following strains of bacteria: Temecula 1—X. fastidiosa subsp. fastidiosa, Wild-type Pierce's Disease isolate, ATCC 700964; XF15-1-Temecula 1; ΔpilA::Km; Ann—1-X. fastidiosa subsp. sandyi, oleander isolate, ATCC 700598; Dixon—X. fastidiosa subsp. multiplex, almond isolate, ATCC 700965; Ca-Vc1—X. fastidiosa, coffee isolate; Ca-VIIc2—X. fastidiosa, coffee isolate; Ca-Ic2—X. fastidiosa, coffee isolate; XF15.7—X. fastidiosa Temecula 1 Salvo; XF15.11—X. fastidiosa Temecula 1 Sano; XF15.12—X. fastidiosa Temecula 1 Prado; XF15.16—X. fastidiosa Temecula 1 Sano; XF15.28—X. fastidiosa Temecula 1 Salvo; XF15.37—X. fastidiosa Temecula 1 Paz; XF15.38—X. fastidiosa Temecula 1 Paz; XF15.51—X. fastidiosa Temecula 1 Prado; XF134-155, 161-163—X. fastidiosa isolate from V. vinifera, Santa Clara County, Calif.; XF156-160, 164, 165—X. fastidiosa isolate from V. vinifera, Sonoma County, Calif.; XF166-173—X. fastidiosa isolate from V. vinifera, Napa County, Calif.; XF174-183—X. fastidiosa isolate from V. vinifera, Uvalde County, Tex.; and the like.

The phage nutrient of the present invention may be a dry formulation phage control agent supplied at a range of 0.3-1.0% w/w of the capsule. For example, the phage nutrient may be in the range of about 1.2 mg up to about 4 mg, about 2 mg up to about 3.2 mg or about 2.8 mg. The phage nutrient is directly incorporated within the polymer core of the present invention and is dispersed during rehydration of the capsule once inserted into the plant. The phage nutrient of the present invention may include, but is not limited to, a trypticase SB nutrient, a nutrient lysate Broth, a lysate broth/glycerol combination, a sterile skim milk, a freeze dried lysates or a combination thereof.

In certain embodiments, the present invention includes a film which coats the capsule. The film may be formed of an ultra disintegrate polymer combined with a tylose suppression agent or formation inhibitor. The ultra disintegrate polymer may include Hydroxypropylcellulose (L-HPC) co-mixed with sodium croscarmellose (cross-linked). The ultra disintegrate provides a medium for dispersal of the tylose inhibiting compound directly into the vascular system of the plant. The tylose suppression agent or formation inhibitor eliminates the development of vascular occlusions (tyloses), which may prevent the dispersion of the bacteriophages. The tylose suppression agent or formation inhibitor may include, but is not limited to salicylic acid, jasmonic acid, methyl salicylate, methyl jasmonate, chitosan, minooxyacetic acid, aminoethoxyvinylglycine, or a combination thereof.

A method of making the present invention may include the following steps. A homogeneous mixture is prepared by weighing the amounts of each ingredient. The type alpha polymer and PVP-K30 release facilitator ingredient are mixed until completely homogenous. The type beta polymer is prepared by mixing with Trypticase SB nutrient until thoroughly homogenized. After mixing is complete the lyophilized phage sample is added along with the stannous octate catalyst. The type alpha polymer, type beta polymer, bacteriophage nutrient, dispersal enhancement polymer and bacteriophage samples are then co-mixed with the stannous octate catalyst until completely homogenous. The mixture is then placed in the capsule mold and the molds are sealed and compressed. The molds are retained at room temperature (25 degrees C.) for two hours. The molds are then opened to release the formed capsules, which are then prepared for the final coating.

The coating is a mixture of PVP polyvinyl prrrlidone dissolved in ethyl alcohol, a super-disintegrate, and a low substituted hydroxypropylcelluose (L-HPC), which is mixed into a polymer base until homogenous. The capsule film coating may include about 1.0 mg up to about 2.0 mg of L-HPC, about 40 mg up to about 50 mg of absolute ethyl alcohol, about 3.5 mg up to about 4.5 mg of sodium coscarmellose, and about 0.4 mg up to about 0.8 mg of salicylic acid. To make a batch of coating, about 5.75 grams hydroxyproplycellulose (L-HPC) may be added to about 207 grams of absolute ethyl alcohol at 25 degrees C. until 2.7% solids of HPC of the solution is reached. About 17.25 grams of sodium croscarmellose is added to the HPC solution while continuous mixing progresses at 25 degrees C. until 10% solids of HPC/sodium croscarmellose suspension. Salicylic acid powder is then added, such as about 1.2 grams, and the mixture is again stirred until the powder is dispersed to form the film coating. The capsules are then placed in a fluid bed containing the film coating material and then allowed to dry and harden at room temperature (25 degrees C.).

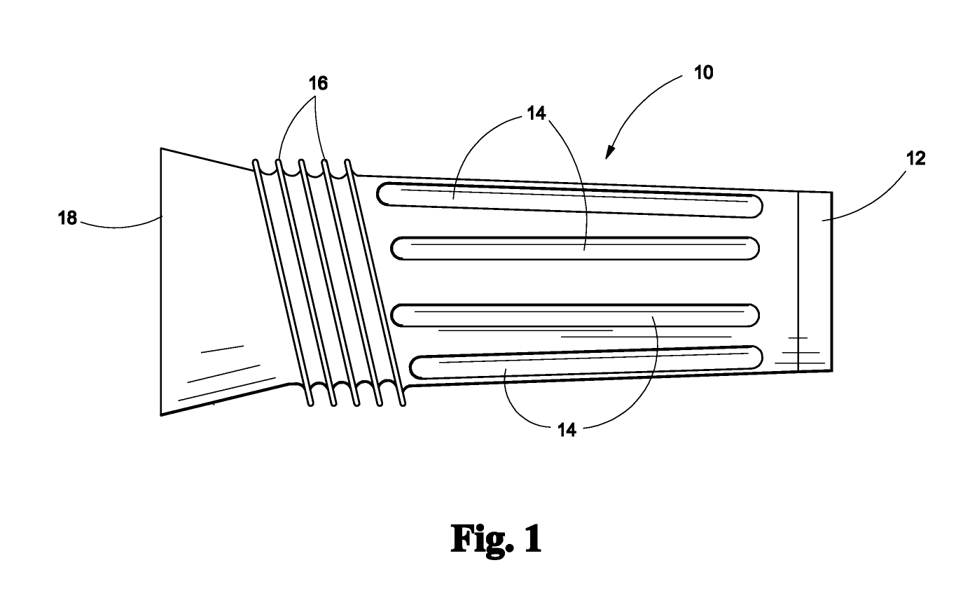

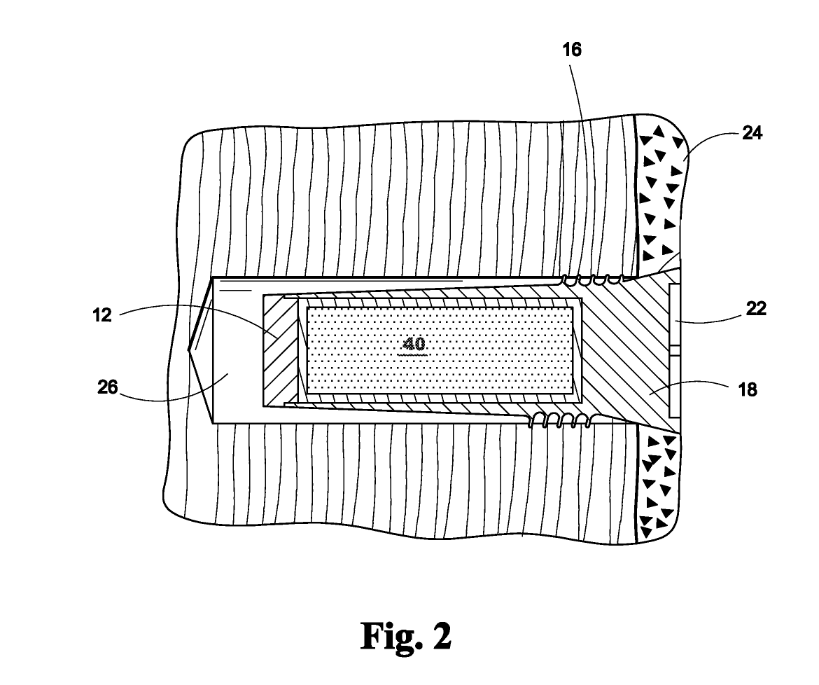

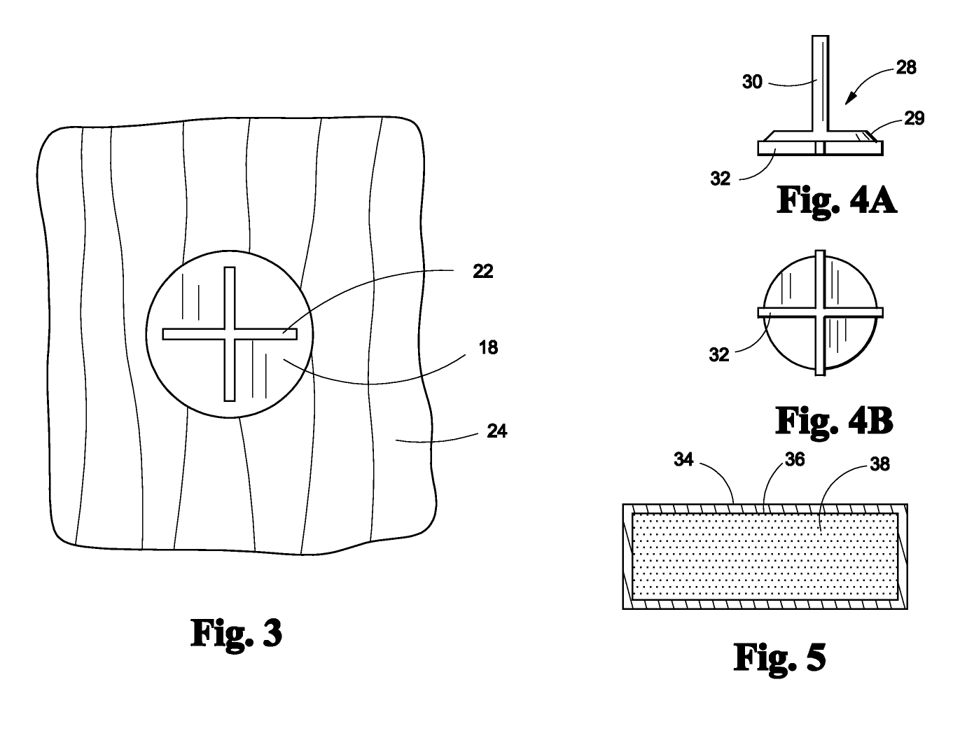

As illustrated in FIGS. 1 through 5, the present invention may be delivered to plant tissue 24 using an implant shell 10. The implant shell 10 may be formed of a plastic. In such embodiments, the implant shell 10 may include a sidewall having a first end and a second end. The first end may be a closed end, and the second end may include a rim forming an opening leading into an inner housing. The capsule 40, including the film coating 34, the polymer core 36, the bacteriophage and bacteriophage nutrients 38, may fit through the opening and may be disposed within the inner housing. A cap 12 secures to the rim, containing the capsule 40 within the implant shell 10. A plurality of ventilation slots 14 may be formed through the sidewall along its longitudinal axis in between the first end and second end for the purpose of cross flow of cell sap, allowing the contents of the capsule 40 to escape the implant shell 10.

In certain embodiments, the first end may include a head portion 18. The head portion 18 may include an upper surface substantially perpendicular with the sidewall. The upper surface may include a female notch 22 formed to receive a raised male notch 32 of a head 29 of a driver bit 28. In certain embodiments, the head portion 18 tapers towards the second end. Further, the head portion 18 may include a male threaded portion 16 formed of raised plastic threads. The tapered head portion 18 allows the implant shell to wedge into the plant tissue 24. The threaded portion 16 serves to anchor the implant shell 10 in the borehole 26 to prevent expulsion of the implant shell 10, and to facilitate removal and replacement.

To insert the implant shell 10 within plant tissue 24, a borehole 26 is cut into the plant tissue 24. The borehole 26 may be formed just above the root crown by drilling about ¼″ with a drill bit set having a depth limiter. A shank 30 of the driver bit 28 may be secured to a power tool operable to rotate the driver bit 28. The implant shell 10 is at least partially inserted into the borehole 26, the raised male notch 32 is inserted into the female notch 22. The implant shell 10 is then driven into the borehole 26. Once inserted, the capsule 40 slowly releases the bacteriophage over about a 90-730 day period treating and potentially eliminating any Xylella fastiodisa or Xanthonomas within the plant.

It should be understood, of course, that the foregoing relates to exemplary embodiments of the invention and that modifications may be made without departing from the spirit and scope of the invention as set forth in the following claims.

What is claimed is:

1. A pharmaceutical composition comprising a lyophilized bacteriophage or an expression thereof present in an amount effective for the treatment of Xylella fastiodisa or Xanthonomas in a plant, a bacteriophage nutrient, and a water soluble polymer.

2. The pharmaceutical composition of claim 1, wherein the water soluble polymer comprises polydimethysiloxane with a terminal hydroxyl group.

3. The pharmaceutical composition of claim 2, wherein the water soluble polymer further comprises tetra-n-propyl-silicate.

4. The pharmaceutical composition of claim 2, wherein the water soluble polymer is mixed with stannous octoate.

5. The pharmaceutical composition of claim 1, further comprising a dispersal enhancement polymer.

6. The pharmaceutical composition of claim 5, wherein the dispersal enhancement polymer is polyvinylpyrrolidone.

7. The pharmaceutical composition of claim 1 in a capsule form.

8. The pharmaceutical composition of claim 7, further comprising a film coating the capsule form, wherein the film comprises a tylose suppression agent.

9. The pharmaceutical composition of claim 8, wherein the film further comprises an ultra disintegrate polymer.

10. The pharmaceutical composition of claim 9, wherein the ultra disintegrate polymer is a combination of hydroxypropylcellulose and sodium croscarmellose.

11. The pharmaceutical composition of claim 8, wherein the tylose suppression agent is salicylic acid.

12. The pharmaceutical composition of claim 1, wherein the lyophilized bacteriophage is selected from the group consisting of siphophages, podophages, and M13 phage.

13. The pharmaceutical composition of claim 1, wherein the bacteriophage nutrient is a lyophilized.

14. The pharmaceutical composition of claim 1, wherein the bacteriophage nutrient is tryptic soy broth.

15. An implant shell comprising:
a sidewall comprising a first end comprising a closed end and a second end comprising a rim forming an opening leading into an inner housing, and a plurality of ventilation slots formed through the sidewall; and
a cap securable to the rim, wherein
the capsule of claim 6 is disposed within the inner housing.

16. The implant shell of claim 15, wherein the closed end comprises a tapered head portion.

17. The implant shell of claim 16, wherein the tapered head portion comprises a female notch sized to receive a driver bit.

18. The implant shell of claim 17, further comprising a male threaded portion formed on an outer surface of the sidewall.
